(19) United States
(12) Patent Application Publication
(10) Pub. No.: US 2008/0273475 A1
(43) Pub. Date: Nov. 6, 2008

(54) Reconfigurable computer bus

(75) Inventors: Nissanka Bodhi Priyantha, Redmond, WA (US); Feng Zhao, Issaquah, WA (US); Dimitrios Lymberopoulos, New Haven, CT (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/799,806

(22) Filed: May 3, 2007

(51) Int. Cl. H04L 12/28

(52) U.S. Cl. 370/257

(57) ABSTRACT

A bus system in which a bus controller, such as a complex programmable logic device, manages a communication channel coupling modules which can implement a node in a sensor network and/or an embedded system device. The system abstracts the communication channel from communicating processors of the modules. A processor of each module interacts with the communication channel through the bus controller. In this manner, the communication channel is decoupled from the processor, allowing different processors running at different speeds to share the communication channel without impacting throughput of the communication channel. The bus controller and the processors of the modules can employ a handshake protocol to asynchronously communicate with each other. The bus controllers can employ a reconfigurable TDMA protocol to communicate with each other and/or communicate between modules.

### BACKGROUND

Sensor networks and embedded systems are employed in a variety of applications including, for example, environmental and industrial monitoring, healthcare, smart homes, entertainment and the like. The diverse nature of these applications requires re-configurability and extendibility at the hardware platform level to meet application-specific needs. Traditionally, this has been achieved by adding an application-specific daughter board with sensors and actuators to a main processing board that typically includes a processor and a radio. This one-application, one-platform approach serves the application needs well but at the cost of potentially redundant development effort. The resulting platform is often limited in its ability to accommodate the diverse computing needs of different applications with the same main processor board.

More recently, modular sensor network and embedded system platforms have been proposed to enable plug-and-play customization of a single platform for several different application domains. These platforms generally focus on flexibility, scalability and re-configurability of resources and comprise a collection of commonly used hardware modules that share the same well-defined interfaces. These interfaces allow the seamless interconnection of these modules in any order and combination. Each module provides some computation, storage, sensing, and/or communication resources. Users can choose a set of hardware modules that best meet the application/research needs and quickly create custom sensor network or embedded system platforms without having to build new hardware from scratch.

However, the design of modular sensor network and embedded system platforms can be challenging. Since multiple hardware modules with different resources are interfaced together to form a sensor node or a embedded platform, the need for sharing every module's data across the stack of modules tends to be a bottleneck in modular architectures. In most cases traditional serial buses such as I²C and SPI (serial peripheral interface) or serial protocols such as RS232 are used to communicate data across the different modules in the stack. These serial buses have two main drawbacks. First, the buses do not scale well with the speed of commonly used embedded processors. For example, the high speed mode of the often used addressable I²C bus is 400 KHz, while the different microprocessors used in sensor nodes and embedded systems can be clocked up to 4 MHz, 8 MHz and 60 MHz. Second, these buses scale poorly with the number of modules in the stack since only a single pair of modules can use the bus at any given time.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

A computer bus system in which a bus controller, such as a complex programmable logic device, manages a communication channel coupling a stack of modules is provided. The stack of modules can be components of a sensor network and/or an embedded device.

The system abstracts the communication channel from communicating processors of the modules as a processor of each module interacts with the communication channel through the bus controller. In this manner, the communication channel is decoupled from the processor, allowing different processors running at different speeds to share the communication channel without impacting throughput of the communication channel. The bus controller can employ a protocol (e.g., a hand shake-based protocol) to asynchronously communicate with the local processor. In one example, each bus controller uses a hand-shake based asynchronous protocol to communicate with the local processor, and a time-division multiple access (TDMA) based protocol to communicate with other bus controllers.

For example, the system can employ a TDMA-based protocol on a parallel bus for efficient data sharing among multiple processors. In this manner, time-critical data can be shared without delay among different modules of a node. The system further allows components of an application to span across different processors/modules without incurring overload. An asynchronous interface can decouple the processor of each module from the communication channel and allows the communication channel to operate at the maximum speed while letting the processors focus on real-time task(s).

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer bus system.

FIG. 2 illustrates an exemplary timing diagram of an interface for writing a single byte of data to a bus controller.

FIG. 3 illustrates an inter-module communication channel architecture.

FIG. 4 illustrates a method of writing a byte of data to a bus controller.

FIG. 5 illustrates a method of reading a byte of data from a bus controller.

FIG. 6 illustrates a computing system operable to execute the disclosed architecture.

### DETAILED DESCRIPTION

The disclosed computer bus system architecture provides for bus controllers (e.g., a complex programmable logic device (CPLD)) to manage a communication channel coupling modules (e.g., components of a sensor node and/or an embedded platform). As such, the system abstracts the communication channel from communicating processors of the modules as a processor of each module interacts with the communication channel through the bus controller. Thus, the communication channel is decoupled from the processor, allowing different processors running at different speeds to share the communication channel without impacting throughput of the communication channel. The bus controller can employ a protocol (e.g., a hand shake-based protocol) to asynchronously communicate with bus controller(s) of other modules.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

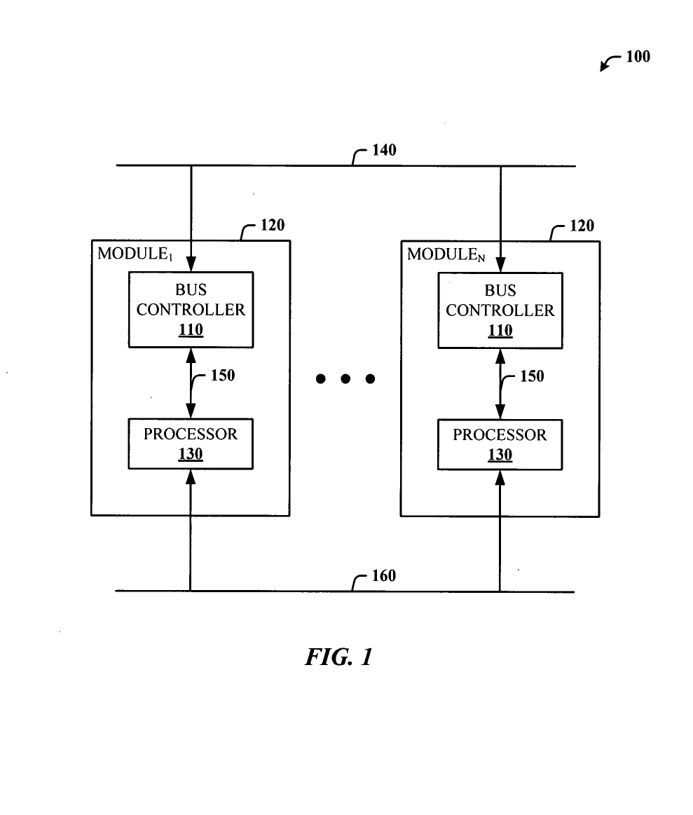

Referring initially to the drawings, FIG. 1 illustrates a computer bus system 100 having a plurality of modules 120, with each module having a bus controller 110 and a processor 130. The bus controller 110 manages a communication channel 140 (e.g., parallel bus) coupling the modules 120. For example, the bus controller 110 can be a programmable logic device (PLD), a CPLD, an application-specific integrated circuit (ASIC), and the like. In one embodiment, the system 100 employs a reconfigurable, time division multiple access (TDMA) protocol to facilitate communication between modules 120, and a handshake-based asynchronous communication protocol for communication between the processors 120 and the bus controller 110.

The system 100 provides a flexible, efficient and reconfigurable architecture that can fit the needs of modular sensor network and/or embedded system platforms. The architecture is based on resource efficiency, processor independence, scalability, fairness, and re-configurability.

Resource efficiency refers to an ability of the communication channel 140 to operate at the maximum possible speed, as defined by the communicating processors 130. For example, the channel 140 can operate much faster when data is being exchanged between two faster processors 130 (e.g., advanced RISC machine 7 (ARM7) processors) compared to two slower processors (e.g., MSP430 microcontrollers).

Regarding processor independence, in one embodiment, the communication channel 140 is not aware of the capabilities of two communication end points, for example, processors 130. In this manner, resource efficiency can be achieved without having to explicitly configure parameters of the communication channel 140 according to the communicating processors 130 capabilities. This allows the communication channel 140 to transparently support a diverse set of processors that can vary from low-end CPUs (e.g., AVR, MSP430 and the like) to more capable processors (e.g., ARM7, PXA, etc.).

In one embodiment, the system 100 is scalable, as end-to-end communication channel delay is not significantly affected by the number of modules 120 in a stack. Further, each module 120 in the stack can use the communication channel 140 independently of the other modules 120 as the module 120 does not have to stall and wait for another module 120 to complete data exchange before the module 120 starts sharing data. Additionally, the communication channel 140 can be adjusted, for example, by a user to optimize the communication channel 140 without a need to modify hardware.

The system 100 abstracts the communication channel 140 from the communicating processors 130. A local processor 130 on each module 120 interacts with the communication channel 140 (e.g., a parallel) bus through the bus controller 110 (e.g., a low-power CPLD). In this manner, the communication channel 140 is decoupled from the local processor 130, allowing different processors 130 running at different speeds to share the communication channel 140 without impacting throughput of the communication channel 140. In one embodiment, to facilitate fairness, a TDMA-based protocol implemented in the bus controllers 110 allows multiple processors 130 to exchange data substantially simultaneously. In this embodiment, the communication channel 140 is a parallel bus. The high data rate enabled by the parallel bus combined with the TDMA protocol create a near real-time inter-module communication channel 140 that scales well with the number of modules in the stack.

In one embodiment, processor independence and resource efficiency can be achieved by employing an asynchronous interface bus 150 (e.g., a separate 8-bit parallel bus) between the processor 130 and the bus controller 110. This enables the bus controller 110 to be transparently interfaced to one of the processors 130 (e.g., running at any speed). The asynchronous nature of the interface enables the processor 130 to transfer data at speed usually limited by the processor clock speed because of a relatively high clock speed of the bus controller 110.

The advanced functionality of the system 100 comes at the expense of a small increase in power consumption due mainly to the bus controller 110. However, the flexibility afforded by the bus controller 110 outweighs the small power overhead.

In one example, the system 100 can be employed in a research platform designed to facilitate rapid prototyping and experimentation. Complex programmable logic devices can provide an abstraction of the hardware layer that drastically simplifies modification at the protocol level requiring little change to hardware.

For example, the system 100 can support real-time event handling. In this example, the system 100 is employed in an application which constantly interacts with the environment (e.g., detection of an abnormally high temperature indicating a fire, detection of an abnormal physiological signal, arrival of a radio packet, etc.).

Additionally, the system 100 can support fine-grained power management. In many sensing and mobility applications, nodes are powered by battery or salvaged energy sources. It can be desirable to be able to shut down components when not in use and scale up or down operation voltage and/or frequency of the components in order to accommodate task needs while conserving energy and other resources.

In one embodiment, the system 100 is a collection of stackable hardware modules 120 that share a well-defined common interface. Physically, each module 120 comprises a circuit board and connectors that enable other modules 120 to be plugged on both top and bottom of that module 120. The modules 120 can be general purpose processing boards and/or special purpose boards such as radio boards for wireless communication, sensor boards for sensing physical phenomena, power boards for supplying power to a stack of modules 120, and the like. In one example, each board (e.g., except for the power board) has a local processor 130. Having a local processor 130 on each module 120 enables efficient real-time event handling. The processor-per-module approach also allows a more customizable aggregation of processing power appropriate for a given application.

In one embodiment, in addition to the components that implement basic functionality of a particular module 120, each module 120 can have a low power configuration processor that can be used to configure the stack of modules 120 and/or reprogram the main processing components on each hardware module 120.

In one example, each module 120 can connect to the communication channel 140 and the asynchronous interface bus 150 for inter-processor communication through a uniform hardware interface. The interface facilitates stacking of combinations of hardware modules 120, for example, to implement a sensor platform and/or an embedded device for an application.

Optionally, a set of switchable serial buses enables dynamic pair-wise communication between processors 130, for example, using standard serial protocols such as RS232 and SPI (serial peripheral interface). A first configuration bus 160 (e.g., multi-master I²C) can be used to configure and manage the stack of modules. A second configuration bus (not shown) (e.g., separate multi-master I²C bus) can be used for secondary processors that are responsible for configuring and managing the stack of modules 120. Moreover, the communication channel 140 (e.g., a 24-bit wide parallel bus) and the asynchronous interface bus 150 (e.g., an 8-bit wide daisy chain parallel bus) can be interfaced to the processor 130 through the high speed, low power bus controller 110 (e.g., CPLD).

In one example, to achieve low power operation without compromising performance of the communication channel 140, a CPLD can be employed that can operate at a maximum speed of 200 MHz with power consumption that can vary from approximately a few mW up to 260 mW due to embedded frequency scaling capabilities. This hardware configuration expands the available data buses used in other modular sensor node and/or embedded system platforms with a bus controller-based communication channel 140 which can have several advantages.

First, the communication channel 140 is abstracted by the bus controller 110. The processor 130 only communicates with the bus controller 110 and does not need to be aware of the bus implementation details. Since the communication channel 140 is controlled by the bus controllers 110 and not the processors 130, local processors 130 on individual hardware modules 120 can enter a deep sleep mode to reduce power consumption, while other processors 130 on different hardware modules 120 can actively communicate data over the communication channel 140.

Next, performance of the communication channel 140 depends on an operating frequency of the bus controllers 110 and not on the operating frequency of the processor 130. This enables different hardware modules 120 with different processors 130 running at various clock speeds to share the same communication channel 140 without affecting its maximum speed.

Further, the communication channel 140 does not have to serialize/de-serialize the data before/after transmission since parallel lines (e.g., of up to 64 bits width) can be used for data exchange. Finally, the communication channel 140 is easily reconfigurable since it is solely controlled by the bus controller 110 (e.g., a CPLD). Programming the bus controllers 110 with a high level hardware description language (e.g., Verilog Hardware Description Language (VDHL)) facilitates the process of designing and using a new communication protocol without having to change the actual hardware design. This approach significantly expands the flexibility of the existing state-of-the-art stack-based architectures by enabling programmers to optimize the communication channel 140 according to the specific application requirements while using general purpose hardware modules 120.

As discussed previously, the communication channel 140 can support high speed inter-module 120 communications. In one embodiment, a communication protocol is provided based on the hardware architecture of the system 100. The communication protocol (1) defines how processors 130 on different modules 120 are wired together, (2) specifies a protocol for sharing data among the processors 130 on different modules 120, and (3) defines the bus controller 110 interface through which the bus controller 110 reads/writes packets from/to the processor 130 on the modules 120.

In this embodiment, a shared parallel bus architecture is employed to connect the processors 130 on different modules 120 together. In this configuration, the processors 120 on different modules 130 share a parallel bus (e.g., 24-bit data bus and several control signals) as the communication channel 140. This approach enables direct communication between any pair of modules 130 on the communication channel 140. This makes the communication delay between any pair of modules 130 small and generally constant regardless of the module 130 location in the stack. The common shared bus employs mechanisms for efficiently sharing the bus and for avoiding collisions due to multiple simultaneous transmissions. In this example, several control signals, including common r set and clock signals are employed as well as a TDMA-based bus protocol that enables efficient sharing of the communication channel 140.

Those skilled in the art will recognize that while the communication channel 140 is described as a 24-bit parallel bus, any suitable bus (e.g., serial, daisy chain and the like) can be employed between the bus controller 110 and the processors 130. All such buses are intended to be encompassed by the hereto appended claims.

As discussed previously, in one embodiment, a TDMA-based protocol is employed by the system 100. The communication protocol for sharing the communication channel 140 can prevent collisions when multiple modules 120 in the stack attempt to use the communication channel 140 at the same time, and, (2) multiplex access to the communication channel 140 so that modules 120 can send data almost immediately without blocking other modules 140 in the stack. With the TDMA protocol, time is divided into slots (e.g., identical) and each module 120 in the stack is assigned a single unique slot. The processor 130 on each module 120 is allowed to send data only during its assigned time slot, all the other modules 120 that do not transmit during a given slot listen to the channel 140 for valid data. This approach enforces fairness among the different modules 120 since the communication channel 140 access is divided (e.g., equally) across the modules 120.

In one example, the duration of each slot is equal to the time required to successfully transmit and receive a single data packet over the communication channel 140. In this example, the communication channel 140 is 24-bits wide which can define a packet size. Of these twenty four bits, the most significant byte contains addressing information, and the remaining two bytes are the data payload. Each module 120 in the stack can be assigned a unique 4-bit address. The four most significant bits of the addressing byte specify the destination while the remaining four bits specify the source. A special broadcast address enables broadcasting over the bus. Therefore, independently of the addressing mode used (e.g., unicast or broadcasting), for every data packet, three bytes are sent over the parallel bus: one address byte and two data bytes.

The system 100 can, optionally, include the asynchronous interface bus 150 (e.g., 8-bit wide parallel data bus) for communication between the processor 130 and the bus controller 110. The asynchronous interface bus 150 allows the communication end points to operate at their maximum speed without sharing any clock information. In addition, an asynchronous interface bus 150 can minimize the use of bus controller 110 resources, leaving the remaining resources for implementing other advanced features of the communication channel 140 (e.g., such as larger memory and/or support for multiple slots per module 120).

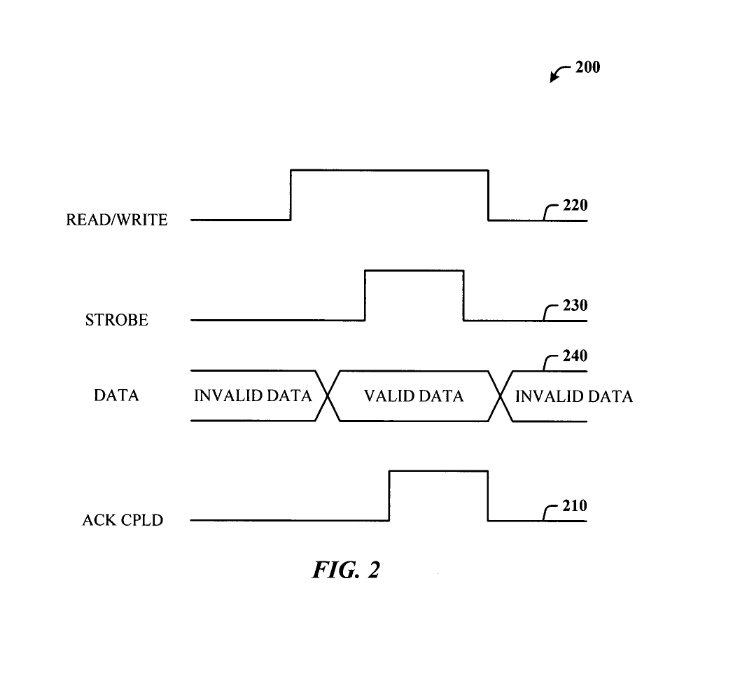

Turning to FIG. 2, an exemplary timing diagram 200 illustrating an interface for writing a single byte of data to the bus controller 110 is illustrated. First, a processor 130 waits for an “ACK CPLD” signal 210 to become low. Next, the processor 130 raises a “READ/WRITE” signal 220 and then outputs the data byte on the asynchronous interface bus 150. The processor 130 then raises a “STROBE” signal 230 to indicate that data is ready to be read by the bus controller 110. The bus controller 110 acquires data 240 on the asynchronous interface bus 150 and raises the ACK CPLD signal 210 to indicate that it has read the data. After detecting the rising edge of the ACK CPLD signal 210, the processor 130 lowers the STROBE signal 230 and then lowers the READ/WRITE signal 220. After detecting the falling edge of the STROBE signal 230, the bus controller 110 lowers the ACK CPLD signal 210. The process of reading a byte from the bus controller 110 is similar. The only difference now is that the READ/WRITE signal 220 is kept low by the processor 130 and the data 240 is controlled by the bus controller 110 and not the processor 130.

In this embodiment, since the communication channel 140 is twenty four bits wide while the asynchronous interface bus 150 shared between the processors 130 and the bus controller 110 is only eight bits wide requires the processors 130 to perform three consecutive byte read/writes in order to read/write a single data packet. The first byte written to the bus controller 110 provides a destination address. In one example, when a value of the address byte is between 0x00h and 0x0Fh, the data is transmitted as a unicast packet. If the address byte is equal to 0x0Fh the data packet is broadcast on the communication channel 140. In both cases, the next two bytes represent the data payload to be sent over the bus. In one example, the bytes written to the bus controller 110 are first processed by a processor interface module to include source address information, before the bytes are written to a transmission FIFO buffer, as discussed below. The processor interface module modifies the address byte (first byte written) such that the four most significant bits correspond to the destination address and the least four significant bits correspond to the source address.

Besides unicast and broadcast transmission of data packets, the processor interface allows the processor to configure several parameters of the communication protocol. In particular, the processor 130 can set an address of the bus controller 110, a slot used by the bus controller 110 as well as a total number of slots used. In one example, the slot assigned to the bus controller 110 can be set by setting the address byte to 0xA0h. In this case the second byte defines the slot assigned to the bus controller 110 and the third byte defines the total number of slots. The address of the bus controller 110 can be set by setting the address byte to 0xB0h. In this case, the second byte defines the address assigned to the bus controller 110 and the third byte is ignored. When setting the address and slot number information, no data packets are transmitted over the communication channel 140.

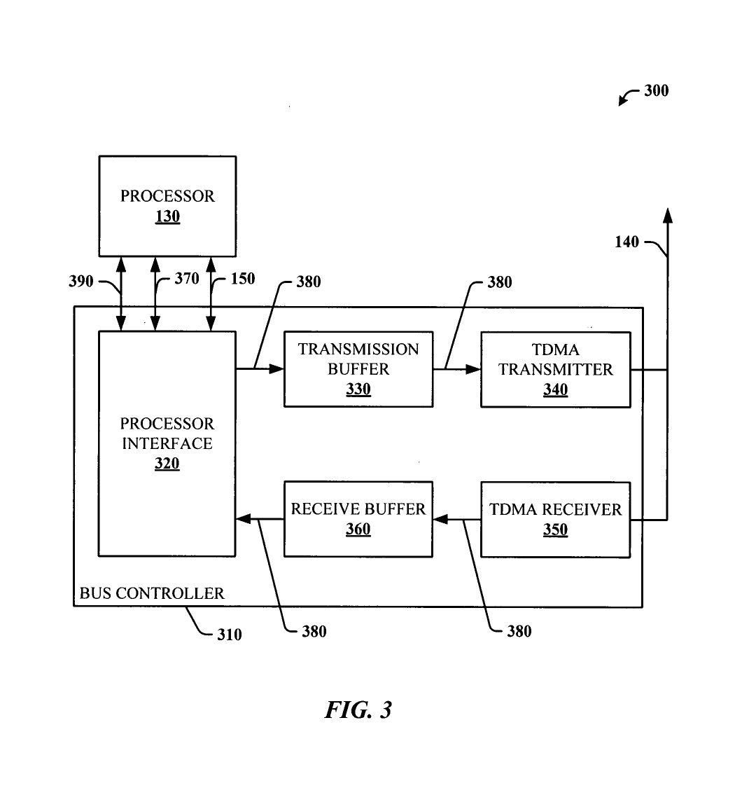

Referring to FIG. 3, an inter-module communication channel architecture 300 is illustrated. The architecture includes one or more processors 130 (of FIG. 1) and a bus controller 310 (similar to bus controller 110). The bus controller 310 includes a processor interface component 320 that is responsible for communication between the bus controller 310 and the processor 130 on each module 120 of FIG. 1. The processor interface component 320 allows the processor 130 to read/write packets from/to the bus controller 310 and set the address, the slot, and the total number of slots. Each data packet the processor 130 sends to the bus controller 310 can be written to a transmission buffer 330 (e.g., circular FIFO buffer). A TDMA transmitter 340 continuously checks the transmission buffer 330; when the buffer 330 is not empty the transmitter 340 reads the first available packet, waits for an assigned slot, and transmits the packet on to the communication channel 140. When the slot for the transmitter 340 is deactivated, the transmitter 340 surrenders control of the communication channel 140. A TDMA receiver module 350, running in parallel, can monitor the communication channel 140 at the beginning of every slot. If a valid packet is on the communication channel 140 and the address decoding is successful then the packet is written to a receive buffer 360 (e.g., circular FIFO buffer).

In one example, when a packet is written or read in either or both of the transmission buffer 330 or/and receive buffer 360, memory status signals 370 directly connected to the processor 130 and the other modules 120 are updated. In that manner, the processors 130 as well as both the TDMA transmitter 340 and the TDMA receiver 350 are aware of the memory status (e.g., full or empty) and the TDMA transmitter 340 and/or the TDMA receiver 350 can begin reading packets when packets are available. For example, the buffers (330 and 360) can be implemented as circular FIFOs that support simultaneous read/write operations for maximum performance.

In one embodiment, internal buses 380 between the individual modules of the bus controller can be twenty four bits wide to minimize a number of clock cycles required for transferring a packet from the input to the output of the communication channel 140 bus. In that manner, only two and a half bus controller 310 clock cycles are used to transfer a data packet from the process interface module 320 to the TDMA transmitter 340, and vice versa. Signal lines 390 (e.g., read/write, strobe, data, ACK CPLD, etc.) can facilitate asynchronous communication between the processor 130 and the bus controller 310, as described previously.

As noted previously, with the TDMA protocol, time slots are assigned to modules 120 in the stack. It is to be anticipated that some modules 120 might not always send data during the time slots for the module 120. As a result, processors 130 at different modules 120 can be stalled waiting for the module 120's slot to become active, even though the communication channel is not being used. This can introduce delays in the communication channel 140.

Optionally, applications can optimize the performance of the system 100. When a module 120 does not need to use the communication channel 140, the module 120 can surrender the module 120's time slots. This can result in a reduction of a total number of slots used. As such, the smaller the number of slots in the stack the less time a module 120 has to wait for the corresponding module slot to be activated. In one example, the process interface 320 can enable setting of the slot used by each module 120 as well as a total number of slots at runtime. In this way, performance of the TDMA can be adjusted according to the runtime application requirements.

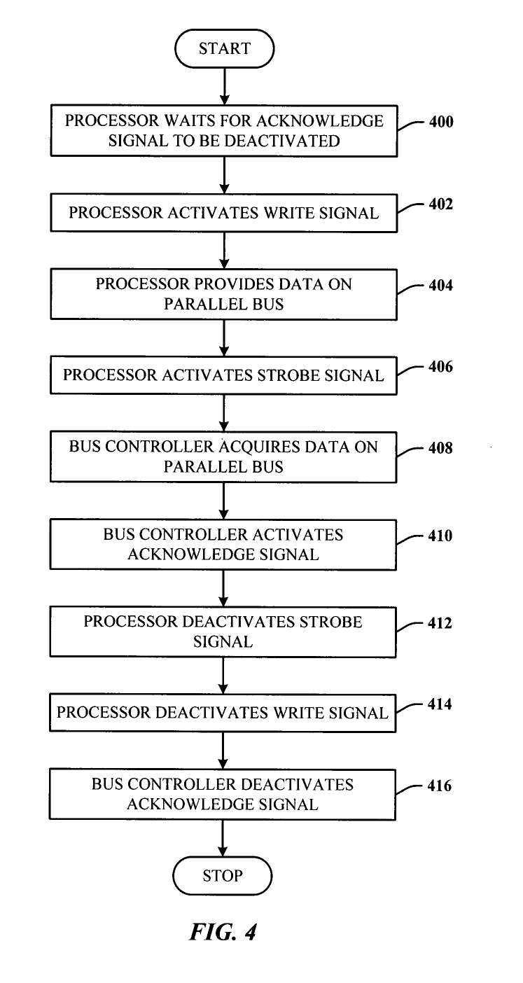

FIG. 4 illustrates a method 400 of writing a byte of data to a bus controller. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 400, a processor waits for an acknowledge signal (e.g., ACK CPLD signal 210) to be deactivated. At 402, the processor activates a write signal (e.g., READ/WRITE signal 220). At 404, the processor provides data on a parallel bus (e.g., asynchronous interface bus 150). At 406, the processor activates a strobe signal (e.g., STROBE signal 230). At 408, a bus controller acquires the data on the parallel bus. At 410, the bus controller activates an acknowledge signal (e.g., ACK, CPLD signal 210). At 412, the processor deactivates the strobe signal, for example, in response to the acknowledge signal. At 414, the processor deactivates the write signal. At 416, the bus controller deactivates the acknowledge signal, for example, in response to deactivation of the write signal.

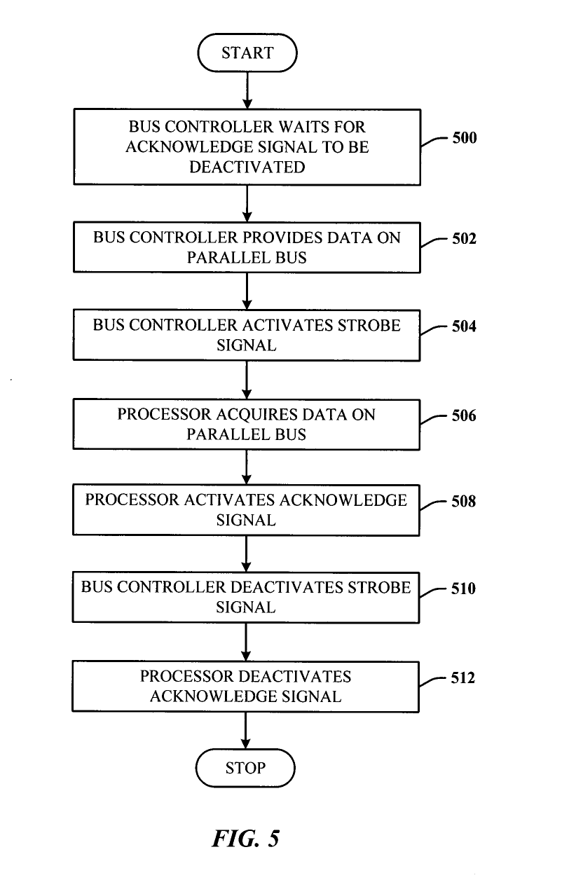

FIG. 5 illustrates a method 500 of reading a byte of data from a bus controller. At 500, the bus controller waits for an acknowledge signal to be deactivated. At 502, the bus controller provides data on a parallel bus. At 504, the bus controller activates a strobe signal. At 508, a processor acquires the data on the parallel bus. At 510, the bus controller deactivates the strobe signal. At 512, the processor deactivates the acknowledge signal.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

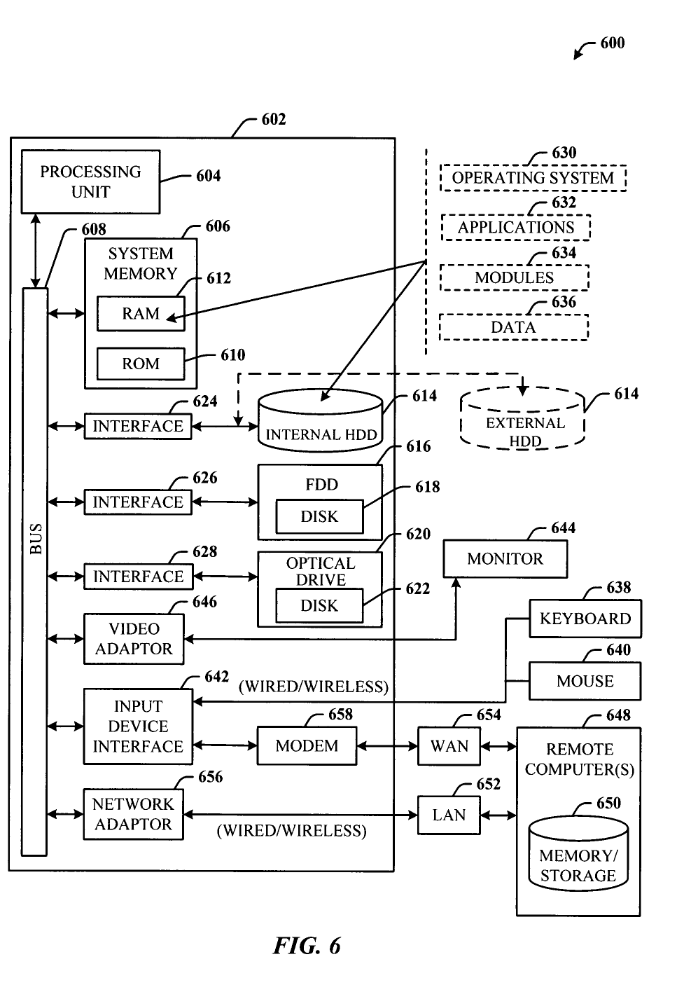

Referring now to FIG. 6, there is illustrated a block diagram of a computing system 600 operable to employ and/or interface to the disclosed architecture. In order to provide additional context for various aspects thereof, FIG. 6 and the following discussion are intended to provide a brief, general description of a suitable computing system 600 in which the various aspects can be implemented. While the description above is in the general context of computer-executable instructions that may run on one or more systems, those skilled in the art will recognize that novel embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing and sensing environments where certain tasks are performed by remote processing devices that are linked through a communications network. In a distributed computing environment, program modules can be located in both local and remote memory storage devices.

A system typically can include a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 6, the exemplary system 600 for implementing various aspects can include a computer 602, the computer 602 including a processing unit 604, a system memory 606 and a system bus 608. The system bus 608 provides an interface for system components including, but not limited to, the system memory 606 to the processing unit 604, as well as to an external implementation of the sensing system described herein and/or an internal implementation. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data. Referring to FIGS. 3 and 6, the system bus 608 can be the communication channel 140 or including capabilities for interfacing thereto.

The computer 602 further includes an internal hard disk drive (HDD) 614 (e.g., EIDE, SATA), which internal hard disk drive 614 may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 612, including an operating system 630, one or more application programs 632, other program modules 634 and program data 636. All or portions of the operating system, applications, modules, and/or data can also be cached in the RAM 612. It is to be appreciated that the disclosed architecture can be implemented with various commercially available operating systems or combinations of operating systems.

A user can enter commands and information into the computer 602 through one or more wired/wireless input devices, for example, a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc. Such devices support communicating with the sensing system

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the local network 652 through a wired and/or wireless communication network interface or adapter 656. The adaptor 656 may facilitate wired or wireless communication to the LAN 652, which may also include a wireless access point disposed thereon for communicating with the wireless adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Referring to FIGS. 1 and 6, in one embodiment, the bus 608 can be the communication channel 140 (e.g., parallel bus) while processing unit 604, system memory 606, interface 624, 626, 628, video adaptor 646, input device interface 642 and/or network adaptor 656 are modules 120.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer bus system, comprising:
a plurality of modules, each module comprising a processor and a bus controller that manages a communication channel coupling the plurality of modules, where the bus controller employs a reconfigurable protocol to asynchronously communicate with the processors.

2. The system of claim 1, wherein the protocol is a time division multiple access protocol.

3. The system of claim 1, wherein the bus controller is at least one of a complex programmable logic device or an application-specific integrated circuit.

4. The system of claim 1, wherein the communication channel is a parallel bus at least twenty four bits wide.

5. The system of claim 1, further comprising an asynchronous interface bus coupling the bus controller and the modules.

6. The system of claim 5, wherein the asynchronous interface bus is based on handshake signals.

7. The system of claim 1 employed in a sensor network to communicate with sensors.

8. The system of claim 1 employed as an embedded device platform.

9. The system of claim 1, wherein at least one processor operates at speed that is different than another processor.

10. The system of claim 1, wherein the bus controller allows processors of the modules to operate at different speeds while sharing the communication channel.

11. A bus system, comprising:
a plurality of modules, each module including a processor and a programmable logic device for managing a parallel bus that interconnects the plurality of modules, where the programmable logic device and the processors employ a handshake protocol for asynchronous communications.

12. The system of claim 11, further comprising an asynchronous interface bus for interconnecting the programmable logic device and the processors.

13. The system of claim 12, wherein the asynchronous interface bus is an eight bit parallel bus.

14. The system of claim 11, wherein the parallel bus employs a time division multiple access protocol to share the parallel bus across a multiple of bus controllers.

15. The system of claim 11, further comprising a configuration bus for configuring the programmable logic device and the modules.

16. The system of claim 11, the programmable logic device further comprised a processor interface for transferring packets from the processors for communication across the parallel bus.

17. The system of claim 11, further comprising signal lines that facilitate asynchronous communication between the processor and the programmable logic device.

18. A computer-implemented method of writing a byte of data from a bus controller, comprising:
waiting for an acknowledge signal to be deactivated;
activating a write signal;
providing data on a parallel bus;
activating a strobe signal;
deactivating the strobe signal in response to activation of the acknowledge signal; and,
deactivating the write signal.

19. The method of claim 18 employed to transfer data from a processor to the bus controller in a sensor network.

20. The method of claim 18, further comprising:
acquiring data on the parallel bus by the bus controller;
activating the acknowledge signal by the bus controller; and,
deactivating the acknowledge signal in response to deactivation of the write signal.
